(19) United States
(12) Patent Application Publication
(10) Pub. No.: US 2014/0042075 A1
(43) Pub. Date: Feb. 13, 2014

(54) SCALE INHIBITOR

(71) Applicant: A. O. SMITH CORPORATION, Milwaukee, WI (US)

(72) Inventors: Wei Ding, Nanjing (CN); Bu Qiu, Nanjing (CN); Baolin Liu, Nanjing (CN); Leyun Lin, Nanjing (CN); Yuping Shi, Nanjing (CN); Lin Kuang, Nanjing (CN)

(73) Assignee: A. O. SMITH CORPORATION, Milwaukee, WI (US)

(21) Appl. No.: 13/962,703

(22) Filed: Aug. 8, 2013

(30) Foreign Application Priority Data
Aug. 9, 2012 (CN) 201210283452.6

(51) Int. Cl. C02F 5/10

(52) U.S. Cl. CPC C02F 5/105
USPC 210/284; 210/503

(57) ABSTRACT

The present invention provides a combined scale inhibitor and scale inhibiting device. The combined scale inhibitor contains organophosphorus filter materials, ceramic filter materials and polyphosphate filter materials. The organophosphorus filter materials are the granular filter materials of liquid organophosphorus scale and corrosion inhibitor while the said ceramic filter materials are the granular filter materials containing oxide ceramic powder. The said scale inhibiting device is comprised of a tank, a water inlet, a water outlet, an organophosphorus filter material layer, a ceramic filter material layer and a polyphosphate filter material layer in the said tank. The said organophosphorus filter material layer contains organophosphorus filter materials, which are the granular filter materials of liquid organophosphorus scale and corrosion inhibitor. The said ceramic filter material layer contains ceramic filter materials, which are the granular filter materials containing oxide ceramic powder.

### CROSS REFERENCE TO RELATED APPLICATIONS

This application claims priority to Chinese Patent Application No. 201210283452.6, filed Aug. 9, 2012, the contents of which are incorporated herein by reference.

### BACKGROUND

The present invention relates to a combined scale inhibitor and scale inhibiting device for filtering the water in a water heater.

In order to prevent the water heater from scaling, the water in the heater can be filtered. Currently, chemical complexometric masking is one of the most relatively effective methods.

Chemical complexometric masking is also called scale inhibition. The commonly-used scale inhibitors include polyphosphate, organophosphorus, and polycarboxylic acid scale inhibitor. Polyphosphate has previously been used as a corrosion and scale inhibitor for a long time and is the condensation polymer of orthophosphates. Sodium tripolyphosphate (Na₅P₃O₁₀) and sodium hexametaphosphate (Na₆P₆O₁₈) are frequently used in water quality stabilization treatment at a dosage of about 2-5 mg/L and 1-5 mg/L respectively. Instead of producing better effects, an increase in dosage will form white precipitates as it exceeds the solubility of polyphosphates in water. The solubility of commercially available polyphosphates is generally around 4 ppm. In addition, polyphosphates can form a protective coating on the surface of the metal under certain conditions and inhibit corrosion.

The organophosphorus scale inhibitor includes methylene phosphonic acid, e.g. ethylenediamine tetramethylene phosphonic acid (EDTMP) and amino trimethylene phosphonic acid (ATMP), and diphosphonic acid, e.g. 1-hydroxy ethylidene-1,1-diphosphonic acid (HEDP). Both kinds of organophosphorus scale inhibitors, which do not easily hydrolyze and adapt to a wide pH range, feature better anti-scaling effects, strong heat stability, low dosage, and corrosion inhibition as well. They are often used at a dosage of 1-5 mg/L.

The polycarboxylic acid scale inhibitor mainly belongs to an anionic scale inhibitor, with the wide use of sodium polyacrylate, polyacrylic acid, polymaleic acid, etc. Generally speaking, these scale inhibitors are used at a dosage of 1-5 mg/L.

Currently, polyphosphates can be used as polyphosphate filter materials. In the present invention, polyphosphate filter materials mainly refer to polyphosphate glass formers or any other kinds of polyphosphate particles. Polyphosphate filter materials are commercially available. For instance, NICOLE™ silicon phosphide, (chemical name: sodium calcium polyphosphate), which is sold by Beijing Sanxinhe Chemical Development Co., Ltd., mainly consists of sodium polyphosphate and calcium oxide. Additionally, a South Korea-based company's NIKRY™ silicon phosphide and South Korea-based SamBu Chemical's NIPHOS™ silicon phosphide are available for sale in the market. The problem is that the polyphosphate filter materials have a high autolysis and so they will dissolve as long as there is water or even water vapor in the container. Whether or not it is effectively used, the polyphosphate filter materials decline and therefore have a service lifetime of half a year. The service lifetime depends on the speed of a single polyphosphate filter material's autolysis. No amount of polyphosphate filter materials will prolong the service lifetime as they are all dissolving. Another problem is that the polyphosphates cannot be used normally under some water-quality conditions as they will dissolve into orthophosphates quickly to generate white precipitates when the temperature rises. Polyphosphate filter materials will then no longer include polyphosphates, resulting in a failure in complexometric masking for calcium and magnesium ions. Instead, they will generate phosphate scale, causing more troublesome scaling. What is worse, polyphosphate filter materials dissolve greatly in still water and have low water solubility. Therefore, when the autolysis exceeds a certain concentration, a large quantity of precipitates will materialize in the container and easily make water cloudy. Thirdly, the breeding of bacteria has not been solved. Lack of disinfection will speed up the breeding of bacteria in the still water, leading to the deterioration and a foul smell of the water.

In addition, the applicants also found that the different water quality in different areas exerts a tremendous influence on the anti-scaling of scale inhibitor. For example the same kind of scale inhibitors which function well in Xuzhou, China may not function well in Guiyang, China.

### SUMMARY

The present invention aims at solving the problems above. The problems are to be solved in the present invention with use of ceramic filter materials, polyphosphate filter materials and organophosphorus filter materials as a combined scale inhibitor. In the meantime, the present invention provides a scale inhibiting device mated with the said combined scale inhibitor.

The present invention overcomes the abovementioned drawbacks in the prior art through a combination of organophosphorus filter materials, ceramic filter materials and polyphosphate filter materials. However, the organophosphorus scale inhibitor often comes in liquid form, resulting in infeasible direct combination with the other two materials. For this reason, the present invention granulates the organophosphorus scale inhibitor and makes it into slow-release granular filter materials, thus addressing the technical problems.

A combined scale inhibitor includes organophosphorus filter materials, ceramic filter materials, and polyphosphate filter materials. The said organophosphorus filter materials are the granular filter materials of liquid organophosphorus scale and corrosion inhibitor, while the said ceramic filter materials are the granular filter materials containing oxide ceramic powder.

A scale inhibiting device includes a tank, a water inlet, a water outlet, an organophosphorus filter material layer, a ceramic filter material layer, and a polyphosphate filter material layer in the said tank. The said organophosphorus filter material layer contains organophosphorus filter materials, which are the granular filter materials of liquid organophosphorus scale and corrosion inhibitor. The said ceramic filter material layer contains ceramic filter materials, which are the granular filter materials containing oxide ceramic powder.

The scale inhibiting device may also include a water layer.

The scale inhibiting device may have a ratio of ceramic filter material layer to polyphosphate filter material layer to organophosphorus filter material layer of (2-8):(2-4):(1-3) by weight.

The ceramic filter material layer, polyphosphate filter material layer and organophosphorus filter material layer may be arranged in the tank along the direction of the water inlet and outlet.

The scale inhibiting device may include a filter device equipped between two adjacent filter material layers of the ceramic filter material layer, polyphosphate filter material layer and organophosphorus filter material layer, and between the water inlet and outlet. Preferably, the said filter device is a piece of filter cloth. More preferably, the filter cloth between the said polyphosphate filter material layer and organophosphorus filter material layer is thicker than other ones.

The combined scale inhibitor or the scale inhibiting device, may include ceramic filter materials prepared by the following method: natural ores are calcined for oxide ceramic powder, which is mixed with dust from a calciner and fly ash from a power plant to generate particles.

The combined scale inhibitor or the scale inhibiting device may have ceramic filter materials consisting of CaO:20-60, MgO:30-90, SiO₂:1-40, Al₂O₃:0.3-20, ZnO:0-15, TiO₂:0-15, Fe₂O₃:0.1-1, SO₂:0.1-2, K₂O:0-3.0 and Na₂O:0-0.6. Preferably, these filter materials are composed of CaO:30-60, MgO:35-55, SiO₂:1-20, Al₂O₃:0.3-15, ZnO:1-10, TiO₂:0.1-3, Fe₂O₃:0.1-0.5, SO₂:0.1-2, K₂O:0-3.0 and Na₂O:0-0.6.

The combined scale inhibitor or the scale inhibiting device, wherein the said liquid organophosphorus scale inhibitor may contain at least one of the organic polybasic phosphonic acid compounds. Preferably, the said liquid organophosphorus scale inhibitor contains at least one of the methylene diphosphonic acid organophosphorus scale inhibitors (amino trimethylene phosphonic acid, ethylenediamine tetramethylenephosphonic acid and diethylenetriamine pentamethylene phosphonic acid), geminal diphosphonic acid organophosphorus scale inhibitor (1-hydroxy ethylidene-1,1-diphosphonic acid and 1-amino ethylidene-1,1-diphosphonic acid) and carboxyl diphosphonic acid organophosphorus scale inhibitor (2-phosphonobutane-1,2,4-tricarboxylic acid). Other aspects of the invention will become apparent by consideration of the detailed description and accompanying drawings.

### BRIEF DESCRIPTION OF THE DRAWINGS

FIG. 1 shows a structural view of a scale inhibiting device with an organophosphorus filter material layer.

FIG. 2 shows a structural view of a scale inhibiting device with a ceramic filter material layer and an organophosphorus filter material layer.

FIG. 3 shows a structural view of a scale inhibiting device with a ceramic filter material layer and an organophosphorus filter material layer and a polyphosphate filter material.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In the figures, the same component is marked with the same symbol, wherein, 1=tank, 2=water inlet, 3=water outlet, 4=ceramic filter material layer, 5=polyphosphate filter material layer, 6=organophosphorus filter material layer, 7=water layer, and 8=damper.

The present invention is further detailed as below. In the present invention, the ratios mentioned all refer to weight ratios, unless otherwise noted.

The applicant found that factors that impact the speed of hydrolysis of polyphosphates include: 1) Temperature; when the temperature rises, the hydrolysis will accelerate. Affected by some catalysts, sodium polyphosphate will see apparent hydrolysis within a few hours and even within a few minutes when the water temperature exceeds 30-40° C.; 2) pH value; the low pH will speed up the hydrolysis while the hydrolysis will stabilize at the pH 6.5-7.5; 3) Fungi and algae microorganisms which can speed up the hydrolysis.

Polyphosphate scale inhibitor has poor heat stability, a main obstacle to its application. It is clear that factors, including water quality, temperature, pH and quantity, have a major effect on the hydrolysis of polyphosphates.

In order to prevent polyphosphates from running off fast, the present invention combines the polyphosphate filter materials with ceramic filter materials and organophosphorus filter materials.

The ceramic filter materials are the granular filter materials containing oxide ceramic powder. Ceramic filter materials are characterized by the release of active oxygen in the presence of water. The release of active oxygen has been proven by chemiluminiscence. With strong oxidizing ability, active oxygen can passivate polyphosphate filter materials in the still water, slowing down the dissolution. Furthermore, the active oxygen released by ceramic filter materials can sterilize water, kill algae and reduce chemical oxygen demand (COD) in water. Meanwhile, it effectively curbs other types of water contamination, such as pollution of trace organic substances, heavy metal pollution and chlorine pollution. The active oxygen is generated during the hydrolysis of ceramic filter materials with the rising pH of the aqueous solution.

The ceramic filter materials are prepared by the following method. Natural ores, which refer to at least one of the magnesite, dolomite, zeolite, illite and medical stone, are calcined for oxide ceramic powder. When necessary, a certain proportion of TiO₂ and/or ZnO can be added to adjust the constituents of oxide ceramic powder. The butyl acetate (organic acrylic resin), diacetone alcohol solution, or water-based acrylic emulsion can be used to treat the surface of oxide ceramic powder, which is mixed with dust from a calciner and fly ash from a power plant, and preferably with other additives to generate ceramic particles. Dust from a calciner is recycled from a calciner exhaust when natural ores are calcined into refractory matters. Fly ash from a power plant is the dust collected from the smokestack of a steam boiler in a thermal power plant and the sources of dust and fly ash are not limited. The ceramic filter materials only need to have the constituents listed below and exert no effect on the release of active oxygen. Other additives include titanium dioxide, reduced iron powder, zinc oxide and activated carbon powder. The ceramic filter materials of the present invention can be both sintering and sintering-free filter materials. If they are sintering-free filter materials, the binder can be added in granulation and act as butyl acetate (organic acrylic resin) or water-based acrylic emulsion. Sintering-free ceramic filter materials can be made with pure water or tap water. Ceramic particles are dried and then roasted at a temperature of 110° C. to 260° C. for 0.5-5 hours. After that, those ceramic filter materials are soaked in water for 0.5-20 hours, in a bid to undergo cleaning and curing. Finally, ceramic filter materials are roasted at a temperature of 110° C. to 160° C. for 1-5 hours. Ceramic filter materials consist of CaO:20-60, MgO:30-90, SiO₂:1-40, Al₂O₃:0.3-20, ZnO:0-15, TiO₂:0-15, Fe₂O₃:0.1-1, SO₂:0.1-2, K₂O:0-3.0, and Na₂O:0-0.6. Preferably, they consist of CaO:30-60, MgO:35-55, SiO₂:1-20, Al₂O₃:0.3-15, ZnO:1-10, TiO₂:0.1-3, Fe₂O₃:0.1-0.5, SO₂:0.1-2, K₂O:0-3.0, and Na₂O:0-0.6. Ceramic particles can be sintered to form sintering filter materials. See CN101565299A for the preparation of ceramic filter materials. See CN101565298A and CN101450856B for the preparation of oxide ceramic powder used in ceramic filter materials.

The organophosphorus filter materials of the present invention are the granular filter materials of liquid organophosphorus scale and corrosion inhibitor. The organophosphorus scale inhibitor is often in the liquid form. In order to realize the technical effects of the present invention, the liquid organophosphorus scale inhibitor needs to be made into solid particles (filter materials), endowing it with performance of corrosion inhibition. It is imperative to guarantee the anti-scaling effects, improve the stability of polyphosphates and control the release of organophosphorus filter materials, so as to secure a long enough service life. To make sure that organophosphorus filter materials are waterproof, with fewer changes in the release rate and consistency of the release amount with the time going by. Moreover, an increase in the dosage of organophosphorus filter materials will not lead to excessive consumption of magnesium alloy sacrificial anode in the water heater. Organophosphorus filter materials will improve the scale inhibition performance of filter water and retain low costs and a long service life.

The granular filter materials of liquid organophosphorus scale and corrosion inhibitor can be prepared by the following method. The method comprises of: 1. blending liquid organophosphorus scale inhibitor and porous materials and drying them; 2. smashing the mixture into a powder; 3. coating the surface of the powder with the first coating agent containing epoxy resin or acrylic resin; 4. blending the coated powder with powder for increasing water resistance; 5. granulating blended powder; 6. coating the surface of particles with powder for increasing water resistance at the later-stage granulation or after the granulation; 7. roasting the particles; 8. coating the surface of roasted particles with the second coating agent containing epoxy resin or acrylic resin, and drying them. Finally, the granular filter materials of liquid organophosphorus scale and corrosion inhibitor are prepared.

The polycarboxylic acid scale inhibitor can be used in organophosphorus penetration as needed. Both the penetration and the second surface coating can be done once or more than once and therefore reach the appropriate penetration amount, strength, water resistance and release rate of organophosphorus. Preferably, the penetration can be done once to three times while the second surface coating once to five times.

In the present invention, the organophosphorus penetrates inorganic porous materials, which is conducive to the slow release of organophosphorus. The liquid organophosphorus scale inhibitor contains organic polybasic phosphonic acid compounds, including the methylene diphosphonic acid organophosphorus scale inhibitor (amino trimethylene phosphonic acid, ethylenediamine tetramethylenephosphonic acid and diethylenetriamine pentamethylene phosphonic acid), geminal diphosphonic acid organophosphorus scale inhibitor (1-hydroxy ethylidene-1,1-diphosphonic acid and 1-amino ethylidene-1,1-diphosphonic acid) and carboxyl diphosphonic acid organophosphorus scale inhibitor (2-phosphonobutane-1,2,4-tricarboxylic acid). During penetration, the liquid organophosphorus scale inhibitor can be used in combination with low-molecular-weight polycarboxylic acid scale inhibitor. The said low-molecular-weight polycarboxylic acid scale inhibitor refers to any one of the sodium polyacrylate, polyacrylic acid or polymaleic acid. The inorganic porous materials may be chosen from activated carbon, hydroxyapatite, zeolite, etc. They can work with fillers, which are chosen from one or more than one of titanium dioxide, calcined aluminum silicate, quartz sand and talcum powder. During penetration, the liquid organophosphorus scale inhibitor can be in the form of an aqueous solution, with no special limit on its concentration, which is, preferably, more than 50%. The ratio of organophosphorus scale inhibitor to porous materials it sticks to can be set appropriately. Preferably, the weight ratio is 0.5:9.5 to 4:1 and 1:2 to 2:1, or 1:1 more preferably. If performing the organophosphorus penetration once fails to result in the ratio above, the procedure can be done many times.

Powder is smashed into 20-200 eyelets. Smashing exposes the powder's non-phosphorus parts.

During the first surface coating, the first coating agent not only contains epoxy resin, but also hardener and thinner. Preferably, the ratio of epoxy resin to hardener to thinner is equivalent to 1:(0.1-0.3):(0.2-5). The first coating agent contains acrylic resin and thinner as well. Preferably, the ratio of acrylic resin to thinner is equivalent to 1:(0.2-5). The first surface coating can be achieved by immersing powder into the first coating agent solution. The epoxy resin can come in the form of solvent-based epoxy resin, e.g. E44 epoxy resin, or water-based epoxy resin. In terms of acrylic resin, water-based acrylic resin, e.g. MC or RW water-based acrylic resin, can be used. Both water-based epoxy resin and water-based acrylic resin can use water as thinner. As for solvent-based epoxy resin, absolute ethyl alcohol and diacetone alcohol can be used as thinners. Preferably, hardener is added into the epoxy resin, for instance, dicyandiamide can be added into water-based epoxy resin while polyamine or other derivatives are added to solvent-based epoxy resin. The first surface coating helps build a barrier layer, which will also play the role of a reinforcement layer for strengthening particles. The reinforcement layer is insoluble in water, prevents granular filter materials from diffusing and therefore keeps materials containing organophosphorus from separating with each other due to the dissolution of organophosphorus. This procedure can be carried out once or more than once according to actual needs.

The blending is performed for powder to be made into particles. The blending and coating with powder for increasing water resistance can resort to the same powder for increasing water resistance. Powder for increasing water resistance is a compound mixed by at least two materials among calcined aluminum silicate, titanium dioxide and quartz sand, wherein the ratio of calcined aluminum silicate to titanium dioxide to quartz sand is (4-0):(8-1):1 by weight. To achieve the purpose of the present invention, the skilled in the art can adopt other proper powder for increasing water resistance. The coated powder and powder for increasing water resistance can be mixed at 4:(1-4). The added powder for increasing water resistance contributes to the improvement of water resistance of organophosphorus filter materials.

It is possible to use a binder during granulation. There is no limit to the variety of binders, so those containing epoxy resin and/or acrylic resin are feasible and epoxy resin can be used along with hardener and thinner. As there is no limit to the hardener, those that are already known in the art can be used. For example, dicyandiamide can be added into water-based epoxy resin as hardener while polyamine or other derivatives are added to solvent-based epoxy resin. At least one of the absolute ethyl alcohol, diacetone alcohol and water can act as thinners. Resin, hardener and thinner can be matched at the ratio of 1:(0.1-0.3):(0.2-5). The binder contains acrylic resin and thinner as well. Preferably, the ratio of acrylic resin to thinner is equivalent to 1:(0.2-5). The water-based acrylic resin can be diluted with water and the advantage of using a water-based binder is that it is easy to operate and environmentally friendly. The solvent-based binder helps make durable and high-strength particles.

The surface of particles is coated with powder for increasing water resistance at the later-stage granulation or after the granulation. The procedure makes a contribution to the strength of granular filter materials and an increase in the diffusion resistance to organophosphorus and slowdown in its release. This procedure can be carried out once or more than once according to actual needs.

The roasting is conducted in a vacuum oven at a temperature of 120-170° C. for one to ten hours.

The roasted particles are coated riding on the second surface coating which can be achieved by immersing powder into the second coating agent solution. The second surface coating can be done with the same coating agent used in the first one. That is to say, the second coating agent not only contains epoxy resin, but also hardener and thinner. Preferably, the ratio of epoxy resin to hardener to thinner is equivalent to 1:(0.1-0.3):(0.2-5). The second coating agent contains acrylic resin and thinner as well. Preferably, the ratio of acrylic resin to thinner is equivalent to 1:0.2-5. Optionally, the second coating agent can contain fillers, which are comprised of calcined aluminum silicate, titanium dioxide, carbon black, bentonite and aluminum tripolyphosphate at a ratio of (5-10):1:(0.01-0.5):(0.1-1):(0.1-1). The ratio of resin to hardener to thinner to filler is 1:(0.1-0.3):(0.2-5):(0.1-2). This procedure can be carried out once or more than once according to actual needs. The second surface coating can ensure that when immersed in water, granular filter materials still remain integrated, despite the diffusion of most of the organophosphorus.

The organophosphorus filter materials can ensure that organophosphorus particles diffuse slowly into the water and other organic or inorganic substances are insoluble in water. As a result, an organic resin net takes shape in the granular filter materials to fence out organophosphorus and connect the superficial organic resin layer on the surface in a bid to ensure the service life and even-pace release of granular filter materials.

The present invention also provides a scale inhibiting device which is comprised of a tank, an organophosphorus filter material layer, a ceramic filter material layer and a polyphosphate filter material layer in the said tank. The said scale inhibiting device includes a water layer.

There is a water inlet and outlet on the tank which are located as needed. A water inlet and outlet or a plurality of inlets and outlets is feasible as, for instance, two outlets can be arranged, with one accessible to the water heater and the other to the cold water. The water inlet is generally located at the bottom of the tank or on the sidewall near the bottom while the outlet is on the top of the tank or on the sidewall near the top. The ratio of ceramic filter material layer to polyphosphate filter material layer to organophosphorus filter material layer is (2-8):(2-4):(1-3) by weight. The ceramic filter material layer, polyphosphate filter material layer and organophosphorus filter material layer are arranged on a porous damper respectively. The gap between two porous dampers forms water layers. A filter device is installed between two layers and at the inlet and outlet. There is no special limit to the filter device, so the commonly-used devices in the art, such as filter cloth and strainer mesh, can be used. A filter device with strong filterability can be provided between the polyphosphate filter material layer and organophosphorus filter material layer. For instance, a piece of filter cloth thicker than those arranged at the inlet and outlet and between two layers can be provided, so as to keep the two kinds of filter materials, especially organophosphorus filter materials, away from the polyphosphate filter materials. This is because an acid environment will spur the dissolution of polyphosphate filter materials in the still water. With pressure exerted from the polyphosphate filter material layer to the organophosphorus filter material layer, the thick filter cloth is capable of slowing down the reverse osmosis of acidic water to the polyphosphate filter material layer to some extent and therefore reduces the dissolution of polyphosphate filter materials. Based on the actual needs, there are different choices of the scale inhibiting device with the total volume of ranging from 0.5 dm3 to 1.0 dm3.

There is no special limit to the order of arrangement of the ceramic filter material layer, polyphosphate filter material layer and organophosphorus filter material layer. As long as it has no influence on the technical effects of the prevention invention, the order of arrangement of three filter material layers can be different as needed. Preferably, the ceramic filter material layer, polyphosphate filter material layer and organophosphorus filter material layer are arranged in the tank along the direction of the water inlet and outlet. This is because after water flows into the scale inhibiting device, it is firstly filtered by the ceramic filter materials which hydrolyzes and releases active oxygen to disinfect water, oxidize impurities in water and drive up the pH slightly. The rising pH precipitates some oxidized impurities, for example, divalent iron ions are oxidized to become trivalent ions and form Fe(OH)₃ and a small amount of CaCO₃ seed crystal, which will be precipitated in the scale inhibiting device. When water runs through the polyphosphate filter material layer, a certain quantity of polyphosphates will be dissolved out. The water will carry 0.5-1.5 ppm of polyphosphates instantaneously, thus chelating and masking calcium and magnesium ions. In a water heater that doesn't work for several days, the still water will constantly dissolve polyphosphate glass formers. As the ceramic filter materials hydrolyze, the pH of water will rise, which is conducive to a decrease in the dissolution rate of polyphosphate filter materials. Meanwhile, two water layers that are sandwiched with the polyphosphate filter material layer prevent the polyphosphates dissolved out from getting oversaturated and generating white precipitates. When water runs through the organophosphorus filter material layer, a small amount of organophosphorus will be dissolved out and the concentration of organophosphorus can reach 0.2-0.5 ppm, resulting in a slight increase in the total contents of phosphorus in water. The acidic organophosphorus will lead to a decrease in the pH of water. The results will stabilize polyphosphates and reduce scaling to some extent when a water heater works. If it is still water, the thicker filter cloth can reduce the dissolution of polyphosphate filter materials, as mentioned above.

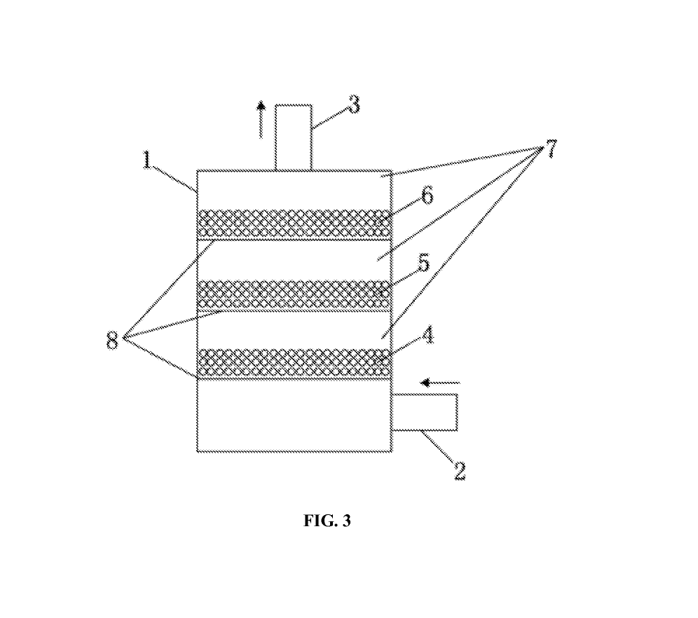

FIG. 3 shows a preferred embodiment of the scale inhibiting device in the present invention. A piece of filter cloth (not shown) can be added to the scale inhibiting device as shown in FIG. 3. As mentioned above, the filter cloth can be provided at the inlet, outlet and dampers. A piece of thicker filter cloth can be provided between the polyphosphate filter material layer and organ phosphorus filter material layer.

The filter water flowing through the scale inhibiting device in the present invention has almost no influence on the magnesium alloy sacrificial anode in the water heater. There is no apparent difference for the cathodic protection and service life of magnesium anode rods and tap water. The scale inhibiting device in the present invention combines water purification and scale inhibition, with the anti-scaling rate exceeding 70%. The anti-scaling rate (namely scaling resistance) is the quotient calculated by dividing the difference between the weight of scaling generated in untreated water (a) and the weight of scaling generated in filtered water (b) by the weight of scaling generated in untreated water (a) under the same conditions, that is (a−b)/a. The scale inhibiting device with the total volume of 0.5 dm³ to 1.0 dm³ can be used for as long as three to five years when there are 240 g of polyphosphate filter materials. The scale inhibiting device in the present invention can prolong the service life of the water heater, reduce the hardness of water, improve comfort for showering and save detergents.

### EXAMPLES

Preparation 1 of Ceramic Filter Materials.

Dolomite is calcined at a temperature of 850° C. for four hours. The carboxymethylated cellulose is used to make an aqueous solution of 1%, in which calcined powder is soaked. Then the powder is dried to form oxide ceramic powder 1. Five grams of oxide ceramic powder 1 is immersed into 200 ml of water. After being measured, the pH of water stands at 10. The value will be 9 to 10 after 300 days. A total of 60 portions of oxide ceramic powder 1 are blended with 20 portions of dust from a calciner, 5 portions of titanium dioxide, 3 portions of reduced iron powder and 12 portions of activated carbon powder. Added with 40 portions of acrylic resin emulsion (prepared by water-based acrylic emulsion with 50% solid content and water in the amount equal to that of the emulsion), the mixture is stirred. A granulator produces particles with particle size of 0.5 mm to 5 mm which are dried in the air and then roasted in an oven at a temperature of 220° C. for three hours. Finally, ceramic filter materials 1 are prepared.

Preparation 2 of Ceramic Filter Materials.

Magnesite is calcined at a temperature of 800° C. for six hours. The acrylic resin is mixed with butyl acetate at a ratio of 2:8. Mineral powder undergoes surface treatment and is roasted at a temperature of 260° C. After that, ceramic powder is dried in a house and finally forms oxide ceramic powder 2. Five grams of oxide ceramic powder 2 is immersed into 200 ml of water. After being measured, the pH of the water stands at 10. The value will be over 9 after 300 days. A total of 20 portions of oxide ceramic powder 2 are blended with 60 portions of dust from a calciner and 20 portions of fly ash from a power plant. Added with 30 portions of acrylic resin emulsion containing 50% water, the mixture is stirred. A granulator produces particles with particle size of 0.5 mm to 5 mm which are dried in the air. The prepared filter materials are soaked into water for one hour to undergo cleaning and curing and are then roasted in an oven at a temperature of 150° C. for three hours. Finally, ceramic filter materials 2 are prepared.

Preparation 1 of Organophosphorus Filter Materials

Forty portions of activated carbon used as porous materials is mixed with 40 portions of ATMP and 40 portions of HEDP and then dried. The mixture is smashed and screened to form around 100 eyelets of powder. E44 epoxy resin and T31 hardener are added into the absolute ethyl alcohol thinner at a ratio of 1:0.3:2. As a result, the first surface coating solution is made. The said powder is immersed into the first surface coating solution to undergo surface coating and then dried. The products are blended with 20 portions of powder for increasing water resistance, which consists of quartz sand and titanium dioxide with the ratio of the two substances being 4:1. A blend of 80 portions of 620 water-based epoxy resin, 8 portions of dicyandiamide and 40 portions of water is used as the binder for granulation. The surface of particles is coated with the said powder for increasing water resistance at the later-stage granulation. The surface coating can be performed by blending granular materials with powder for increasing water resistance. The particles are roasted in a vacuum oven at a temperature of 150° C. for five hours. The particles undergo surface coating again with the said first surface coating solution and drying. After the procedure is repeated three times, organophosphorus filter materials 1 are prepared.

Preparation 2 of Organophosphorus Filter Materials (to Get Organophosphorus Filter Materials 2).

Forty portions of activated carbon used as porous materials is mixed with 20 portions of ATMP and 20 portions of HEDP and then dried. The mixture is smashed and screened to form around 100 eyelets of powder. E44 epoxy resin and T31 hardener are added into the absolute ethyl alcohol thinner at a ratio of 1:0.3:2. As a result, the first surface coating solution is made. The said powder is immersed into the first surface coating solution to undergo surface coating and then dried. The products are blended with 20 portions of powder for increasing water resistance, which consists of quartz sand and titanium dioxide with the ratio of the two substances being 4:1. A blend of 80 portions of 620 water-based epoxy resin, 8 portions of dicyandiamide and 40 portions of water is used as the binder for granulation. The surface of particles is coated with the said powder for increasing water resistance after the granulation (here “after the granulation” is used instead of “later-stage granulation” to echo the Specification). The surface coating can be performed by blending granular materials with powder for increasing water resistance. The particles are roasted in a vacuum oven at a temperature of 170° C. for three hours. The particles undergo surface coating again with the said first surface coating solution and drying. After the procedure is repeated two times, organophosphorus filter materials 2 are prepared. The organophosphorus filter materials have strong water resistance and high release.

Preparation 3 of Organophosphorus Filter Materials (to Get Organophosphorus Filter Materials 3).

Forty portions of activated carbon used as porous materials is mixed with 30 portions of ATMP, 30 portions of HEDP and 20 portions of sodium polyacrylate and then dried. The mixture is smashed and screened to form around 100 eyelets of powder. RW16 water-based acrylic resin is used as the first surface coating solution, with the ratio of RW16 water-based acrylic resin to water being 1:2. The said powder is immersed into the first surface coating solution to undergo surface coating and then dried and smashed again. The products are blended with 20 portions of powder for increasing water resistance, which consists of quartz sand and titanium dioxide with the ratio of the two substances being 4:1. A blend of 80 portions of 620 water-based epoxy resin, 8 portions of dicyandiamide, 20 portions of RW16 water-based acrylic resin and 40 portions of water is used as the binder for granulation. The surface of particles is coated with the said powder for increasing water resistance at the later-stage granulation. The surface coating can be performed by blending granular materials with powder for increasing water resistance. The particles are roasted in a vacuum oven at a temperature of 170° C. for three hours. The particles undergo surface coating again with the said first surface coating solution and drying. After the procedure is repeated five times, organophosphorus filter materials 3 are prepared. The organophosphorus filter materials have steady release and a long service life.

Comparison 1 of the Scale Inhibiting Device.

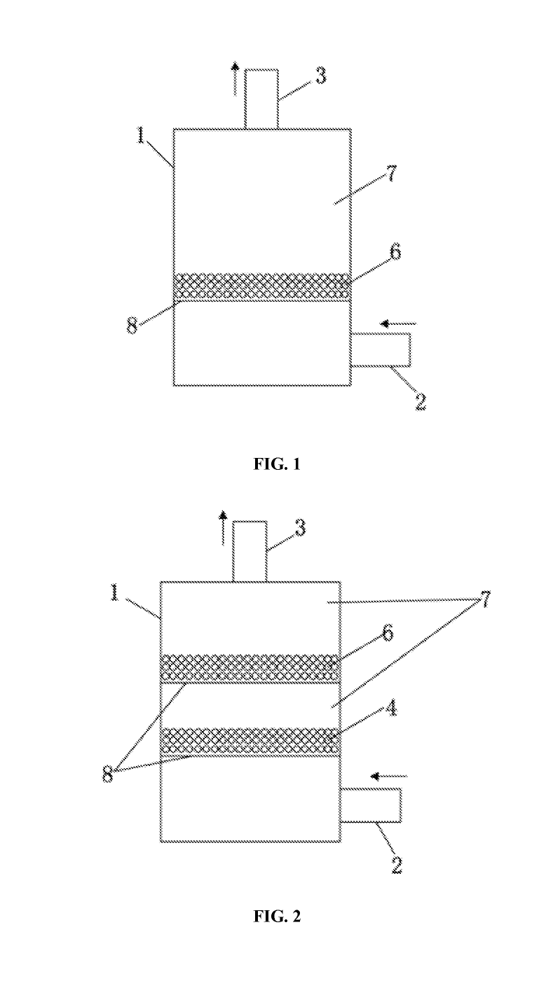

The scale inhibiting device in Comparison 1 is as shown in FIG. 1. The water outlet of the scale inhibiting device is joined to the water inlet of a domestic heater. As shown in FIG. 1, 550 grams of organophosphorus filter materials 1 are used as the scale inhibitor in the scale inhibiting device with a volume of 0.6 dm3. A piece of filter cloth is provided at the water inlet, outlet and porous damper where the scale inhibitor is placed. A test was conducted in Guiyang, China which lasted for five months with 200 tons of water used. Results of the test indicated that compared with that generated in a water heater, the quantity of scaling fell, with the anti-scaling rate of 50% and the sacrificial anode consumption being 0.89 times the used tap water. Therefore, the exclusive use of organophosphorus filter materials as the scale inhibitor cannot obtain an unsatisfactory anti-scaling rate.

Comparison 2 of the Scale Inhibiting Device

The scale inhibiting device in Comparison 1 is as shown in FIG. 2. The scale inhibiting device in Comparison 2 differs from that in Comparison 1 in the use of 300 grams of ceramic filter materials 1 and 240 grams of Nicole® silicon phosphide, namely polyphosphate filter materials (polyphosphate glass formers), which is sold by Beijing Sanxinhe Chemical Development Co., Ltd., as the scale inhibitor. A test was conducted in Guiyang, China the results of which showed that polyphosphate filter materials would generate white precipitates in the still water, leading to an unsatisfactory anti-scaling rate of 25%. A test was conducted in Xuzhou, China with use of the same scale inhibiting device. Results of the test showed that the anti-scaling rate was 98.5% and sacrificial anode consumption was 4 times the used tap water. Therefore, the combined use of polyphosphate glass formers and ceramic filter materials as the scale inhibitor results in a high anti-scaling rate, but accelerates the corrosion to the sacrificial anode, which cannot meet the needs.

To sum up, the water quality has a big influence on the anti-scaling of the scale inhibiting device. The water in Guiyang, China differs from that in Xuzhou, China which is characterized by low hardness, high pH and high iron content. Polyphosphates are unstable in water in Guiyang, China therefore this scale inhibiting device is difficult to be applied to all kinds of water. Furthermore, the combined use of ceramic filter materials and polyphosphate filter materials as the scale inhibitor leads to unsatisfactory corrosion behavior of the sacrificial anode.

Embodiment 1 of the Scale Inhibiting Device.

FIG. 3 shows a structural view of the scale inhibiting device in the present invention. A blend of 300 grams of ceramic filter materials 1 and 200 grams of organophosphorus filter materials 1 and 160 grams of NICOLE™ silicon phosphide, which is sold by Beijing Sanxinhe Chemical Development Co., Ltd., is used as the scale inhibitor. A test was conducted in Guiyang, China by the same method used in Comparison 1 the results of which showed that the anti-scaling rate was 88% and the sacrificial anode consumption was 0.97 times the used tap water. Therefore, the combined use of ceramic filter materials, organophosphorus filter materials and polyphosphate filter materials as the scale inhibitor results in a high anti-scaling rate and prevents the anode consumption. In addition, the five-month test only consumed around 30% of the scale inhibitor and 180 tons of the water. Based on the annual water consumption per household of 60 tons plus the polyphosphates dissolved in the still water, the scale inhibitor has more than three years of service time.

Embodiment 2 of the Scale Inhibiting Device.

With the same structure, the scale inhibiting device in Embodiment 2 differs from that in Embodiment 1 in the use of 200 grams of ceramic filter materials 2,150 grams of organophosphorus filter materials 2 and 240 grams of Niphos® silicon phosphide, which is produced by South Korea-based SamBu Chemical, as the scale inhibitor. A test was conducted in Guiyang, China by the same method used in Comparison 1, the results of which showed that the anti-scaling rate was 92% and the anode consumption was 1.06 times the used tap water, which can be acceptable. Therefore, the combined use of ceramic filter materials, organophosphorus filter materials and polyphosphate filter materials as the scale inhibitor results in a high anti-scaling rate and a slight increase in the anode consumption. In addition, the five-month test only consumed 150 tons of the water and around 25% of the scale inhibitor. Based on the annual water consumption per household of 60 tons plus the polyphosphates dissolved in the still water, the scale inhibitor has more than three years of service time.

Embodiment 3 of the Scale Inhibiting Device.

With the same structure, the scale inhibiting device in Embodiment 3 differs from that in Embodiment 1 in the use of 200 grams of ceramic filter materials 2 and 150 grams of organophosphorus filter materials 3 and 160 grams of NIKRY™ silicon phosphide, which is produced by a South Korea-based company, as the scale inhibitor. A test was conducted in Guiyang, China by the same method used in Comparison 1 the results of which showed that the anti-scaling rate was 98.5% and the anode consumption was 0.96 times the used tap water. Therefore, the combined use of ceramic filter materials, organophosphorus filter materials and polyphosphate filter materials as the scale inhibitor resulted in a high anti-scaling rate and prevented the anode consumption. In addition, the five-month test only consumed 200 tons of the water and around 30% of the scale inhibitor. Based on the annual water consumption per household of 60 tons plus the polyphosphates dissolved in the still water, the scale inhibitor has more than three years of service time.

Thus, the invention provides, among other things, a scale inhibitor. Various features and advantages of the invention are set forth in the following claims.

What is claimed is:

1. A combined scale inhibitor, comprising organophosphorus filter materials, ceramic filter materials and polyphosphate filter materials, wherein the organophosphorus filter materials are granular filter materials of liquid organophosphorus scale inhibitor and the ceramic filter materials are granular filter materials containing oxide ceramic powder.

2. The combined scale inhibitor of claim 1, wherein the ceramic filter materials are prepared by calcining natural ores for oxide ceramic powder, and combining the oxide ceramic powder with calciner dust and fly ash to generate particles.

3. The combined scale inhibitor of claim 1, wherein the ceramic filter materials comprise CaO:20-60, MgO:30-90, SiO₂:1-40, Al₂O₃:0.3-20, ZnO:O-15, TiO2:0-15, Fe₂O₃:0.1-1, SO₂:0.1-2, K₂O:0-3.0 and Na₂O:0-0.6.

4. The combined scale inhibitor of claim 1, wherein the ceramic filter materials comprise CaO:30-60, MgO:35-55, SiO₂:1-20, Al₂O₃:0.3-15, ZnO:1-10, TiO₂:0.1-3, Fe₂O₃:0.1-0.5, SO₂:0.1-2, K₂O:0-3.0 and Na₂O:0-0.6.

5. The combined scale inhibitor of claim 1, wherein the ceramic filter materials consist of CaO:30-60, MgO:35-55, SiO₂:1-20, Al₂O₃:0.3-15, ZnO:1-10, TiO₂:0.1-3, Fe₂O₃:0.1-0.5, SO₂:0.1-2, K₂O:0-3.0 and Na₂O:0-0.6.

6. The combined scale inhibitor of claim 1, wherein the liquid organophosphorus scale inhibitor comprises at least one organic polybasic phosphonic acid compound.

7. The combined scale inhibitor of claim 1, wherein the liquid organophosphorus scale inhibitor comprises a methylene diphosphonic acid organophosphorus scale inhibitor, a geminal diphosphonic acid organophosphorus scale inhibitor and a carboxyl diphosphonic acid organophosphorus scale inhibitor.

8. The combined scale inhibitor of claim 7, wherein the liquid organophosphorus scale inhibitor comprises (i) at least one of amino trimethylene phosphonic acid, ethylenediamine tetramethylenephosphonic acid and diethylenetriamine pentamethylene phosphonic acid, (ii) at least one of 1-hydroxy ethylidene-1,1-diphosphonic acid and 1-amino ethylidene-1,1-diphosphonic acid, and (iii) 2-phosphonobutane-1,2,4-tricarboxylic acid.

9. A scale inhibiting device, comprising a tank, a water inlet, a water outlet, an organophosphorus filter material layer, a ceramic filter material layer and a polyphosphate filter material layer in the tank, wherein the organophosphorus filter material layer comprises organophosphorus filter materials, which are the granular filter materials of liquid organophosphorus scale inhibitor and wherein the ceramic filter material layer comprise ceramic filter materials, which are granular filter materials containing oxide ceramic powder.

10. The scale inhibiting device of claim 9, wherein the scale inhibiting device includes a water layer.

11. The scale inhibiting device of claim 9, wherein the ratio of ceramic filter material layer to polyphosphate filter material layer to organophosphorus filter material layer is (2-8):(2-4):(1-3) by weight.

12. The scale inhibiting device of claim 9, wherein the ceramic filter material layer, the polyphosphate filter material layer and the organophosphorus filter material layer are arranged in the tank along the direction of the water inlet and outlet.

13. The scale inhibiting device of claim 9, wherein a filter device is equipped (i) between the ceramic filter material layer and the polyphosphate filter material layer, (ii) between the polyphosphate filter material layer and the organophosphorus filter material layer, (iii) at the water inlet, and (iv) at the water outlet.

14. The scale inhibiting device of claim 13, wherein the filter device comprises filter cloth and wherein the filter cloth between the polyphosphate filter material layer and the organophosphorus filter material layer is thicker than the other ones.

15. The scale inhibiting device of claim 9, wherein the ceramic filter materials are prepared by calcining natural ores for oxide ceramic powder, and combining the oxide ceramic powder with calciner dust and fly ash to generate particles.

16. The scale inhibiting device of claim 9, wherein the ceramic filter materials comprise CaO:20-60, MgO:30-90, SiO₂:1-40, Al₂O₃:0.3-20, ZnO:O-15, TiO₂:0-15, Fe₂O₃:0.1-1, SO₂:0.1-2, K₂O:0-3.0 and Na₂O:0-0.6.

17. The scale inhibiting device of claim 16, wherein the ceramic filter materials comprise CaO:30-60, MgO:35-55, SiO₂:120, Al₂O₃:0.3-15, ZnO:1-10, TiO₂:0.1-3, Fe₂O₃:0.1-0.5, SO₂:0.1-2, K₂O:0-3.0 and Na₂O:0-0.6.

18. The scale inhibiting device of claim 17, wherein the ceramic filter materials consist of CaO:30-60, MgO:35-55, SiO₂:120, Al₂O₃:0.3-15, ZnO:1-10, TiO₂:0.1-3, Fe₂O₃:0.1-0.5, SO₂:0.1-2, K₂O:0-3.0 and Na₂O:0-0.6.

19. The scale inhibiting device of claim 9, wherein the liquid organophosphorus scale inhibitor contains at least one of the organic polybasic phosphonic acid compounds.

20. The scale inhibiting device of claim 9, wherein the liquid organophosphorus scale inhibitor comprises a methylene diphosphonic acid organophosphorus scale inhibitor, a geminal diphosphonic acid organphosphorus scale inhibitor, and a carboxyl diphosphonic acid organophosphorus scale inhibitor.

21. The scale inhibiting device of claim 9, wherein the liquid organophosphorus scale inhibitor comprises (i) at least one of amino trimethylene phosphonic acid, ethylenediamine tetramethylenephosphonic acid and diethylenetriamine pentamethylene phosphonic acid, (ii) at least one of 1-hydroxy ethylidene-1,1-diphosphonic acid and 1-amino ethylidene-1,1-diphosphonic acid, and (iii) 2-phosphonobutane-1,2,4-tricarboxylic acid.
